(19) United States
(12) Patent Application Publication
(10) Pub. No.: US 2005/0228677 A1
(43) Pub. Date: Oct. 13, 2005

(54) Scheduling events for an itinerary using agents

(75) Inventors: Francis G. McCabe, Palo Alto, CA (US); Jonathan Dale, San Francisco, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/812,791

(22) Filed: Mar. 30, 2004

(51) Int. Cl. G06F 17/60

(52) U.S. Cl. 705/1; 705/14

(57) ABSTRACT

Building an itinerary includes receiving consumer descriptors at a consumer agent operating on behalf of a consumer. Recommended services are identified from a number of services using a service agent operating as a service finder. The recommended services are identified in accordance with the consumer descriptors. A timeline and the recommended services are presented. The following is repeated until a selection of service offerings has been completed in order to build an itinerary of events: determining a selection of a service offering of the recommended services as an event for the itinerary; indicating available times of the selected service offering; and determining a selection of an available time of the selected service offering.

### TECHNICAL FIELD OF THE INVENTION

The present invention relates generally to event scheduling and more particularly to scheduling events for an itinerary using agents.

### BACKGROUND

The introduction of the Internet and the worldwide web has unleashed a flood of information. Some of the information describes activities in which a user may participate. For example, a travel website may provide information about airline flights, or a restaurant website may provide information about menus. Most existing technology, however, provides rigid offerings that do little to simplify or automate the scheduling of activities.

### SUMMARY OF THE INVENTION

In accordance with the present invention, techniques for scheduling events are provided. According to particular embodiments, these techniques enable agents to automatically build an itinerary of events designated by a user.

According to a particular embodiment, building an itinerary includes receiving consumer descriptors at a consumer agent operating on behalf of a consumer. Recommended services are identified from a number of services using a service agent operating as a service finder. The recommended services are identified in accordance with the consumer descriptors. A timeline and the recommended services are presented. The following is repeated until a selection of service offerings has been completed in order to build an itinerary of events: determining a selection of a service offering of the recommended services as an event for the itinerary; indicating available times of the selected service offering; and determining a selection of an available time of the selected service offering.

Certain embodiments of the invention may provide various technical advantages. A system operating according to the techniques of the embodiments provides for dynamic composition of services to build an itinerary. Specifically, these techniques may enable the selection of services to create an itinerary, which may link to the services to fulfill the events of the itinerary. The techniques may enable automated and dynamic aggregation of services to simplify the scheduling of events.

Because of the relatively open nature of interaction among elements of the system, the system may permit any number of entities to schedule and offer services. Thus, the system may be scalable and extensible. Particular embodiments may operate in accordance with publicly developed communication standards. Also, a wide variety of services and service providers may increase flexibility and further enhance the dynamic nature of automated service composition.

The system may support any number of agents acting on behalf of users, service providers, intermediaries, or any combination of the preceding to facilitate dynamic service composition. The agents communicate while operating in the interests of their owners to facilitate the access to and scheduling of services. Each agent can operate according to its particular information to accomplish the goals of its owner. For example, a consumer's agent may operate according to a plan to apply user preferences to select services that match the user's preferences.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates one embodiment of a system for building an itinerary that includes service providers and consumers that operate according to particular embodiments of the present invention;

FIG. 2 is a block diagram illustrating exemplary functional elements of an agent of the system;

FIG. 3 is a block diagram illustrating exemplary functional elements of a service of the system;

FIG. 4 is a logic diagram illustrating interaction between agents and services within the system; and

FIG. 5 is a flowchart illustrating one embodiment of a method for building an itinerary.

### DETAILED DESCRIPTION OF THE DRAWINGS

FIG. 1 illustrates one embodiment of a system 10 for building an itinerary that includes multiple service providers 12 and a consumer 14 coupled by a communication network 16. Each service provider 12 offers a service 18, potentially using a service agent 20 to facilitate offering of the service 18. Consumer 14 includes a consumer agent 22 that facilitates the selection of one or more services 18 to build an itinerary. According to particular embodiments, consumer agent 22 interacts with other elements of system 10 to generate a list of services 18 according to the preferences of consumer 14. Services 18 may be selected from the list to build an itinerary.

According to one embodiment, each service provider 12 represents any suitable collection of components operable to offer access to services 18 through defined interfaces. As used in this document, “each” refers to each member of a set or each member of a subset of the set. Service providers 12 may offer machine readable interfaces that enable structured queries to access and interact with information regarding services 18. For example, a particular service provider 12 may provide access to and interaction with a restaurant reservation system. To provide these operations, service 18 may support any number of features and provide an interface to each one of these features. For example, a restaurant reservation service 18 may offer features such as a reservation availability query feature or a reservation request feature. According to particular embodiments, service 18 may operate according to publicly developed and available standards for communications.

Service providers 12 may include service agents 20 that provide for extended functionality. Service agents 20 may operate as service finders by enabling operations such as the composition of other services and pushing of services to other service providers 12, consumers 14, or both. For example, services 18 may use service agent 20 as a service finder to seek out and compose any number of remote services 18. As another example, service agent 20 may identify other entities that have expressed an interest in a particular type of service 18, and may then contact these entities and advertise the availability of and the features supported by service 18.

System 10 may enable delegation and distribution of functionality among agents. As an example, a service provider 12 may comprise a travel agency. Agent 20 of the travel agency service provider 12 may operate as a service finder and seek out other service providers 12, such as car services, airlines, activities, and other suitable types of services 18, and compose these services 18 into a combined service offering. Travel agency agent 20 may have highly sophisticated processing and analysis engines to provide efficient, cost-effective, or otherwise appropriate travel arrangements. Consumer agent 22 may then access travel agency agent 20 to find services 18 for an itinerary. Consumer agent 22 may also incorporate the combined service as a service link within the itinerary.

According to the illustrated embodiment, service providers 12 register their services 18 with one or more service registries 24. Service registry 24 provides a centralized guide to enable consumers 14 to find services 18. Service registry 24 may include any suitable information for identifying, describing, and locating services 18, and may use any suitable technique for searching for the information such as the structured query language (SQL) technique. For example, for each registered service 18, service registry 24 may include a high level description such as a general description of the service 18 and a network address for contacting service 18. If the general description matches consumer descriptors set by consumer 14, consumer agent 22 may then contact the identified network address, which then links to any appropriate system within service provider 12, such as service 18 or service agent 20. Consumer agent 22 may then query the contacted service 18 for specific information and potentially access the various functions provided by service 18. Although service registry 24 may be used to find services 18, system 10 contemplates consumer agent 22 using any suitable technique for finding services.

Consumer 14 represents any suitable combination and arrangement of components that enable interaction with users and other elements of system 10. Consumer 14 supports dynamic composition of services 18 to build an itinerary. An itinerary may refer to a listing of one or events scheduled for particular times. An event may refer to a service requested for a particular time. Consumer agent 22 may apply consumer descriptors such as consumer preferences or requirements during this process to select and prioritize a list of services from which a user may build an itinerary.

According to one embodiment, consumer agent 22 interacts with other agents to identify services that satisfy consumer requirements and to prioritize the services according to consumer preferences to generate a list of recommended services. Service offerings may be selected from the recommended services and placed in a timeline to generate events of the timeline. According to one embodiment, a service offering may be inserted within an offered timeframe indicating when a service is generally offered. For example, an offered timeframe may indicate the times when a restaurant is open. Available times indicating when the service offering is actually available within the timeframe may be identified. For example, available times may indicate when the restaurant has a table available for a party of two.

An itinerary may provide links to one or more services 18 that may fulfill tasks of the identified events by, for example, making a reservation for a service. For example, an itinerary produced by consumer agent 22 may provide a link to service 18 operating as a service finder, which in turn links to any number of services 18 for fulfilling events, resulting in a hierarchy of itineraries linking to services 18. Consumer agent 22 need not actually achieve tasks, but rather may delegate performance of these tasks to services 18, allowing for a distributed system in which any number of service providers 12 can offer and provide services to consumers 14, other service providers 12, other appropriate entities, or any combination of the preceding.

Consumer agent 22 may be used in any suitable environment. For example, a consumer may use consumer agent 22 to plan a business or vacation trip. As another example, an attendee of an attraction such as a sports event, amusement park, or conference may use consumer agent 22 to build an itinerary. Consumer agent 22 may be used to schedule individual activities, food, transportation, meetings, or any combination of the preceding for the attraction.

Standard technologies may be used to provide interoperability between components of system 10. Standard technologies may include, for example, Simple Object Access Protocol (SOAP), Web Services Description Language (WSDL), Choreography, DARPA Agent Markup Language/Ontology Web Language (DAML/OWL), Universal Description, Discovery, and Integration (UDDI), other suitable standard technology, or any combination of the preceding.

The illustration and the description provided present generic elements for implementing a system to enable selection of recommended services and construction of itineraries that link to multiple services distributed within a network. While the embodiment illustrated includes specific components arranged and operating in particular ways, however, it should be understood that the illustration, the description, and all examples given are provided only to aid in clarifying the basic concepts of these techniques, and none of these are intended to limit the scope of these concepts.

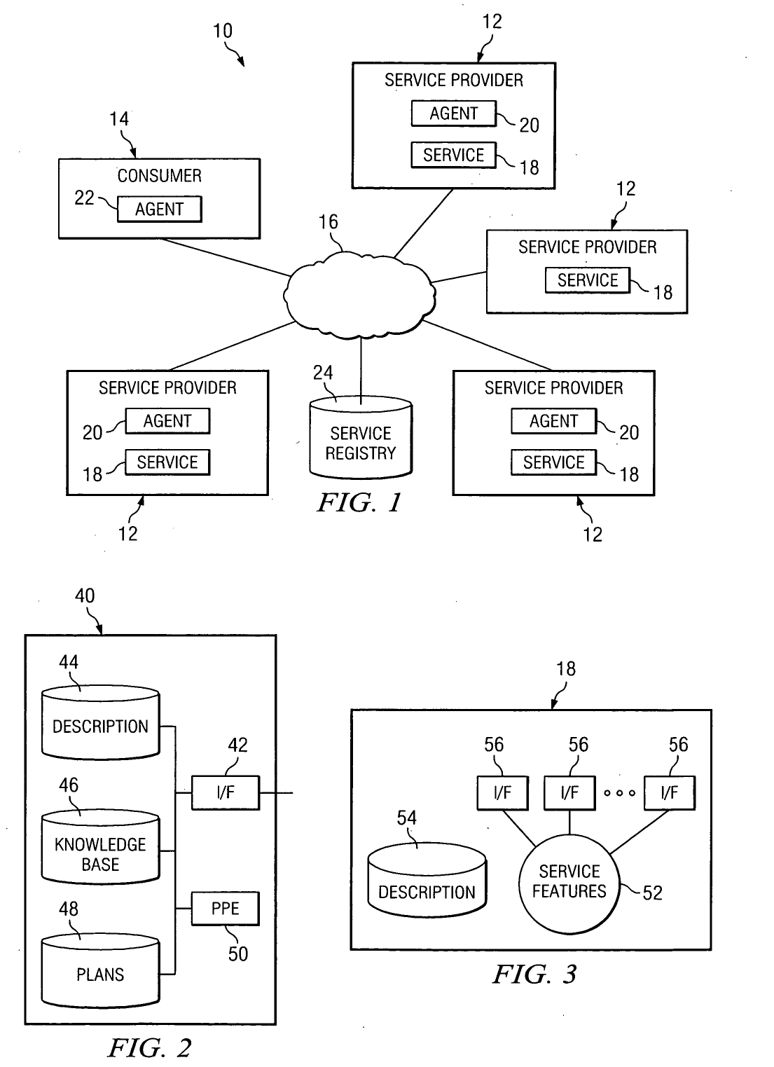

FIG. 2 is a block diagram illustrating exemplary functional elements for an agent 40 that includes an interface 42, a description 44, a knowledge base 46, one or more plans 48, and a plan processing engine 50. Because the operation of many agents such as service agents 20 and consumer agents 22 may be similar, agent 40 and its elements and operations may be described below both generically and specifically with respect to particular types of agents. In general, agent 40 uses plan processing engine 50 to process information from plans 48 using data contained within description 44 and knowledge base 46 in order to schedule, fulfill, or both schedule and fulfill tasks specified within plans 48.

Plans 48 include, in general, goals to be achieved by agent 40. For example, a consumer agent 40 may have plans 48 that include one or more itineraries, which may range from bare templates to completed itineraries. Some plans may specify several tasks in a simple form, whereas other plans may provide more detailed information, up to completed itineraries, which may specify a full set of events and provide links to various services 18 for fulfilling the tasks associated with the events. As another example, a service provider agent 40 may include plans 48 for identifying, interacting with, and providing services 18 to consumers 14. As another example, service provider agent 40 operating as a service finder may have plans that include itineraries expressed in manners similar to those used within consumer agent 40.

Description 44 includes any number of descriptors specifying information associated with the entity served by agent 40. Description 44 may be stored at any suitable memory or database. The descriptors can range from general to itinerary-specific descriptors. As an example, a consumer agent 40 may maintain description 44 that includes a number of consumer descriptors. General consumer descriptors may include names, addresses, award program numbers, and other general data, or any combination of the preceding. General consumer descriptors may also include consumer preferences describing general attributes that typically do not change from itinerary to itinerary, and that may be used to select and prioritize services. For example, consumer preferences may include types of restaurants, preferred airlines, and any other suitable preferences such as preferring an aisle seat on an airplane, a hotel room with a king sized bed, or a restaurant with a specific average meal price.

Itinerary-specific descriptors refer to specific or dynamic descriptors related to one or more particular itineraries. Itinerary-specific descriptors may include consumer requirements that may be specified while defining a particular event or itinerary, and may be used to select a service or to determine availability of a service offering to consumer 14. For example, itinerary-specific descriptors may describe preferences, constraints, or other suitable types of information for constructing an itinerary, such as the time, location, and number of people for an event of an itinerary. If a consumer preference conflicts with a consumer requirement, the consumer requirement may prevail.

A service provider agent 40 may maintain description 44 that includes service descriptions describing services 18. A service description may include service descriptors that range from general to specific. General service descriptors may include, for example, the nature of service 18, how to locate and interface with service 18, the interface languages supported by service 18, other appropriate information, or any combination of the preceding. For example, general service descriptors for a restaurant service provider 12 may include the name, location, type of restaurant, price range, interface languages supported, other appropriate general information, or any combination of the preceding. Specific service descriptors may include precise features offered by service 18 and techniques for interfacing with those features. For example, specific service descriptors for a restaurant service provider 12 may identify features, such as a reservation feature or a take-out order feature, and specify specific syntax for interfacing with these features.

Some or all of description 44 may be exposed to other entities during various operations. A service provider agent 40 may publish some portion of description 44 into service registry 24 to enable other agents to find and directly contact agent 40 for further information. A consumer agent 40 may similarly expose some or all of description 44.

Knowledge base 46 includes information for use by agent 40 to make decisions, negotiate with other agents, perform other operational tasks, or any combination of the preceding, and may use any suitable technique for searching for the information such as the structured query language (SQL) technique. A service provider knowledge base 46 may include an encoding of business logic. For example, an airline knowledge base 46 may include details for pricing of different types of airline tickets. According to particular embodiments, knowledge base 46 may represent one or more legacy or other enterprise systems maintaining business knowledge for an organization. Accordingly, agent 40 can access and make decisions based upon actual information within an enterprise, while providing a wrapper of services around a central knowledge bank. Typically, agent 40 maintains most or all of knowledge base 46 hidden from other entities during operation.

Interface 42 provides a link between agent 40 and other entities of system 10. Depending upon the particular types of communications and configurations within system 10, interface 42 may include any suitable combination of hardware, software, or other logic for interacting with other components. Plan processing engine 50 attempts to satisfy goals set forth within plans 48. A consumer plan processing engine 50 implements plans 48 to schedule events to build an itinerary. A service provider plan processing engine 50 implements plans 48 to aggregate services 18 from multiple service providers 12.

Agent 40 may run on any suitable computer using any suitable operating system such as the APPLE MacOS, MICROSOFT WINDOWS, or REDHAT Linux/Unix operating system. Agent 40 may have any suitable platform such as an Agent Process Interaction Language (April) Agent Platform. The platform may be compliant with any suitable standard or procedure such as with Foundation for Intelligent Physical Agents (FIPA), Web Services, or Semantic Web standards or procedures. Agent 40 may be provided using any suitable programming language such as April, Go!, other suitable programming language, or any combination of the preceding. Other suitable programming technologies may be used as well such as DialoX or Java.

While the embodiment illustrated and the description provided focus on a particular example of agent 40 that includes specific elements providing particular functions, system 10 contemplates agents 40 having any suitable combination and arrangement of elements to support composition of remote services. Thus, the functionalities performed by the particular elements illustrated may be separated or combined as appropriate, and functionalities of some or all of these elements may be implemented by logic encoded in media. Moreover, some or all of the functionalities of agent 40 may be combined or distributed among other elements of system 10.

FIG. 3 is a block diagram illustrating exemplary functional elements for service 18 that includes service features 52, a description 54, and one or more feature interfaces 56. Service features 52 operate to provide various functions supported by service 18. Feature interfaces 56 enable other entities, such as agent 40, to interface with functions provided by service features 52. Description 54 provides a number of descriptors with information about service 18 that may be shared between service 18 and its associated agent. For example, description 54 may include information similar to the service descriptors of description 44.

During operation, agents and other entities of system 10 may access service 18 to query for information and to request service 18 to perform activities. For example, consumer agent 22 may contact service 18 and query information of description 54. In response, service 18 may provide this information to consumer agent 22. For example, an airline service 18 may provide access to an airline reservation system. Airline service 18 may provide information regarding features such as a schedule query feature, a reservation request feature, a flight information request feature, other appropriate feature, or any combination of the preceding.

Consumer agent 22 may access service features 52 using feature interfaces 56. For example, consumer agent 22 may access a flight information feature 52 through interface 56 to determine times and pricing for various flights. If a service offering of the service feature is selected for an itinerary, consumer agent 22 can provide a link to service 18 within the itinerary. If a consumer confirms the itinerary constructed by consumer agent 22, consumer agent 22 can request service 18 to provide the indicated service. For example, consumer agent 22 may access a reservations feature interface 56 to book a flight for the consumer.

Therefore, as provided by this illustration, services 18 may include both functional aspects, such as service features 52 and feature interfaces 56, and data aspects, such as description 54. While illustrated as including specific elements arranged in a particular configuration, however, system⁻¹⁰ contemplates services 18 including any suitable combination and arrangement of elements for providing network accessible services. Thus, system 10 contemplates services 18 including any suitable combination of hardware, software, or other logic and the functionalities of services 18 being incorporated in, provided by, or both incorporated in and provided by any suitable network accessible equipment.

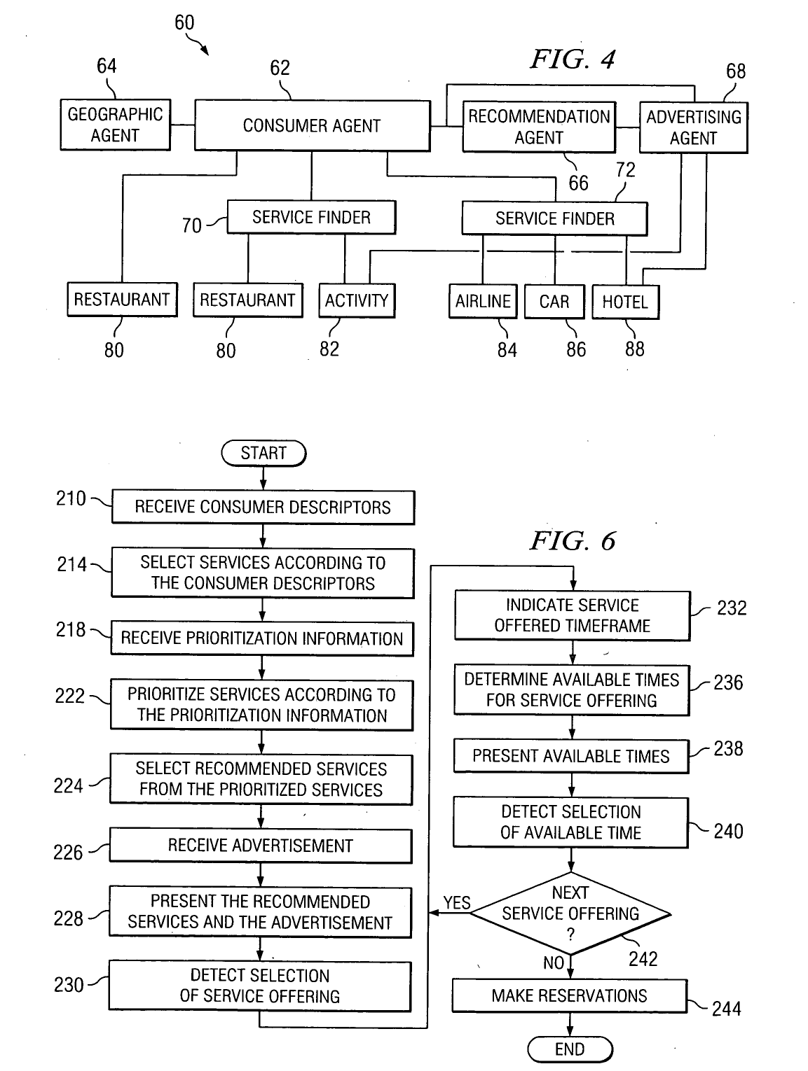

FIG. 4 is a logic diagram illustrating one embodiment of a hierarchy 60 that includes agents may be used to build an itinerary. Agents include a consumer agent 62, a geographic agent 64, a recommendation agent 66, and one or more service finders 70 and 72. Services include one or more restaurant services 80, an activity service 82, an airline service 84, a car service 86, and a hotel service 88.

According to one embodiment of operation, consumer agent 62 provides service provider 70 with consumer descriptors, including consumer preferences and consumer requirements, to find services 80. Service finder 70 compares the consumer descriptors with the service description of each service to generate a list of one or more compatible services. Consumer agent 62 may also receive information from geographic agent 64 and recommendation agent 66. Geographic agent 64 may provide proximity information describing the distances between the consumer and the services. Recommendation agent 66 may provide evaluation information describing the services. Consumer agent 62 may prioritize the services according to the received information to generate a list of recommended services. A consumer may select services from the list to build an itinerary, and may make reservations for the selected services using the itinerary.

According to one embodiment, service finders 70 aggregate search facilities over a number of services. According to the illustrated embodiment, service finder 70 finds services related to restaurants and activities. Service finder 72 may comprise a travel agency service finder 72 that finds travel services such as airline service 84, car rental service 86, and hotel service 88. Service finder 70 and 72 may select services by comparing the consumer descriptors with the service description of each service to determine compatibility values for the services. A list of one or more service offerings that satisfy a compatibility threshold may be generated and returned to consumer agent 62. A compatibility threshold may comprise, for example, a threshold value or threshold ranking that a service may need to satisfy.

Geographic agent 64 determines the locations of a consumer and services and calculates the distance between the consumer and the services to yield proximity information such as proximity metrics, which may be used to select, prioritize, or both select and prioritize services. A service location may refer to the location approximately where a service is offered, for example, the address of a restaurant. A consumer location may refer to the location approximately where the consumer plans to be around the time the service is requested. For example, the consumer location may be the location of where the consumer is staying such as a residence or a hotel. As another example, the consumer location may be the location where the consumer plans to be before or after the time the service is requested, such as a restaurant before a movie.

Recommendation agent 66 provides evaluation information such as evaluation metrics that may also be used to select, prioritize, or both select and prioritize the services. Evaluation information may include popularity information describing the popularity of about the about the services, ratings of the services, other suitable information, or any combination of the preceding. Popularity information may include popularity metrics determined by, for example, the number of consumers who have used the service, the number of times the service has been used, or any other suitable information. Ratings information may include ratings metrics determined by, for example, rating provided by consumers who have used the service, a third party rating system, or other suitable information.

Recommendation agent 66 may gather evaluation information in any suitable manner. For example, recommendation agent 66 may be notified when other consumers make reservations for a particular service. As another example, statistical information about services that have been reserved by other consumers may be provided to recommendation agent 66. The evaluation information may be anonymous to protect the other consumers' identities. Recommendation agent 66 may limit the number of services provided to consumer agent 62.

Services may be selected, prioritized, or both selected and prioritized according to consumer descriptors by any suitable agent such as consumer agent 62 or recommendation agent 66. As an example, services may be prioritized according to the suitability of the services. Suitability may be determined in any suitable manner. An agent may receive prioritization information comprising metrics for prioritizing the services, and may apply a prioritization function to the metrics to calculate the suitability of a service for a consumer. The metrics may comprise, for example, a compatibility metric measuring how well the service matches one or more consumer descriptors, a proximity metric measuring the distance between the consumer and the service, a popularity metric measuring the popularity of the service, other metric, or any combination of the preceding. The prioritization function may weight some metrics more than others. As an example, compatibility may be weighed more than proximity, which may be weighed more than popularity. The services may be ranked according to the suitability.

Advertising agent 68 provides advertisements that may be displayed to consumer through consumer agent 62. Advertising agent 68 may generate an advertisement from a service description. Advertising agent 68 may target specific advertisements for consumers in accordance with the suitability with the advertisement for the consumer. Advertising agent 68 may receive suitability information from another agent, may generate its own suitability ratings, or both. As an example, advertising agent 68 may determine suitability by comparing consumer preferences with service descriptions. Other metrics, however, may be used in the determination of suitability, for example, proximity and popularity metrics may also be used. Payment for the advertisements may be calculated in any suitable manner. As an example, a service may provide payment for advertising agent 68 whenever a reservation is made for the service.

Consumer agent 22 may present a list of recommended services and advertisements by, for example, displaying or playing the list. Consumer agent 62 may present only a certain portion of the prioritized services, for example, the highest ranking five or ten services. A user may select from the list to build an itinerary. When an itinerary is satisfactory, consumer agent 62 may then initiate services using links within the itinerary. For example, consumer agent 62 may transmit credit card information and authorization for reservations to a service or service finder. Similarly, consumer agent 62 may request reservations from restaurant services 80.

Modifications, additions, or omissions may be made to the logic diagram without departing from the scope of the invention. The logic diagram may include more, fewer, or other elements. For example, more, fewer, or other services may be included. Additional or other services may include, for example, tourism activities such as going to a museum, leisure activities such as playing golf or going shopping, or business activities such as booking a room or reserving a projector.

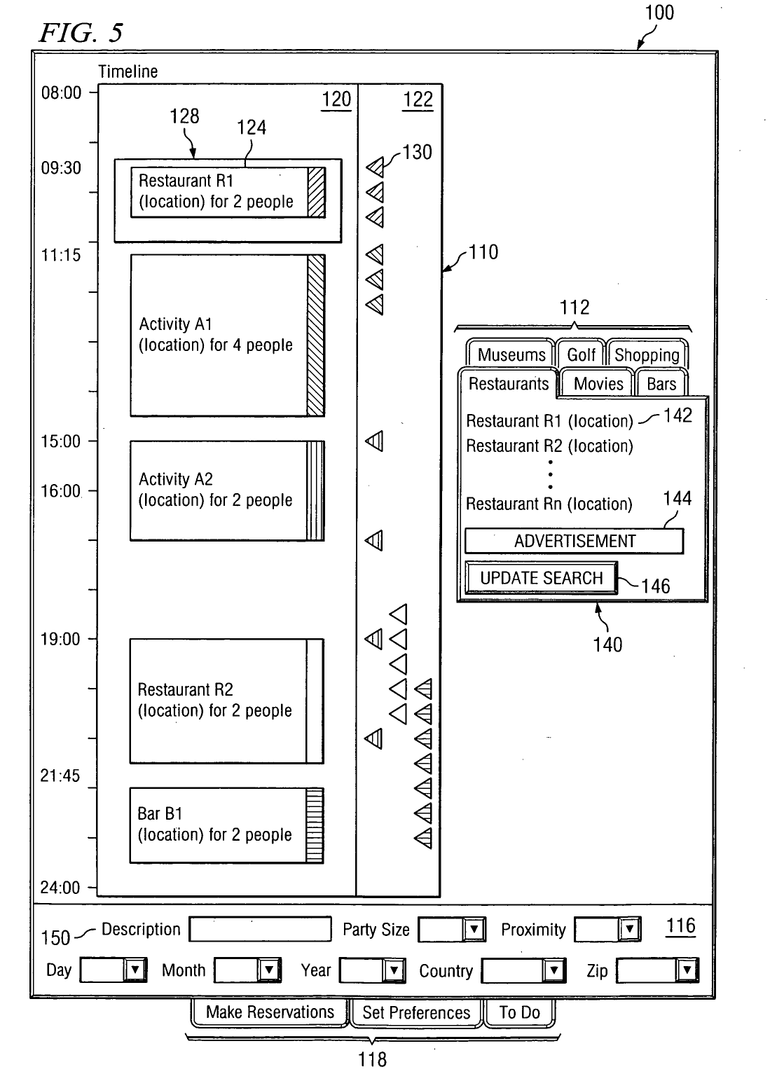

FIG. 5 is a screen shot illustrating one embodiment of a planner 100 that may be used to build an itinerary. Planner 100 includes a timeline 110, a recommended services section 112, a consumer descriptor section 116, and one or more tabs 118. According to one example of operation, a user may provide consumer descriptors in consumer descriptor section 116. Suitable services that are compatible with the consumer descriptors may be displayed in recommended services section 112. A user may select services from recommended services section 112 to schedule events in timeline 110 to build an itinerary.

According to one embodiment, consumer descriptor section 116 may be used to collect consumer descriptors such as consumer preferences and consumer requirements. According to the illustrated embodiment, consumer descriptor section 116 includes windows 150 that may be used to gather consumer descriptors. Windows 150 include a description window for a name describing the day being planned, a party size window for the number of people for which the service is requested, and a proximity window for a maximum distance between the consumer and the services. Windows 150 also include day, month, and year windows into which the date of the event day may be entered. Country and zip code windows may be used to enter the desired location of the events. Day, month, and year windows or description window may also be used to select a timeline 110 for another day.

Recommended services section 112 includes services organized by service type. According to the illustrated embodiment, the service types include museums, golf, shopping, restaurants, movies, and bars. Recommended services section 112 may, of course, include more, fewer, or other service types. A service type section 140 provides a list of recommended services for a particular service type. According to the illustrated embodiment, service type section 140 includes a recommended services list 142, an advertisement 144, and an update search button 146. Recommended services list 142 includes services that may be inserted into timeline 110 to create events to build an itinerary. According to one embodiment, the services of service list 142 may be selected, prioritized, or both selected and prioritized according to consumer descriptors.

Advertisement 144 may include an advertisement provided by advertising agent 68. According to one embodiment, advertisement 144 may be targeted to the consumer according to consumer descriptors. Update search button 146 allows the consumer to update the search. Recommended service section 112 may be dynamically generated updated in response to information from other agents. For example, if a server for a restaurant service goes down, restaurants associated with that restaurant service may be removed from recommended services list 142.

Timeline 110 may be used to schedule events to build an itinerary, and may include a scheduling window 120 and an availability section 122. Service offerings may be selected from recommended services section 112 and inserted into scheduling window 120 to create an event at a particular time. Scheduling window 120 may have a time coordinate. According to one embodiment, the time coordinate may increase in a horizontal direction towards the right, or a vertical direction downwards. According to one embodiment, timeline 110 may include fixed time segments at specific intervals. According to another embodiment, timeline 110 may comprise a fuzzy timeline undivided by fixed time segments. Services may be inserted into the fuzzy timeline, and consumer agent 62 may determine the approximate time where service is dropped.

According to one embodiment, a user may select a service offering from recommended services section 112, drag the service offering to scheduling window 120, and drop the service offering into scheduling window 120 to create the event. An event window 124 describing the event may be created in scheduling window 120 for an event. According to the illustrated embodiment, event window 124 includes the name of the service, the location of the service, and the number of people for whom the service is requested. Event window 124, however, may include other or additional information.

According to one embodiment, event window 124 may indicate whether an event has been reserved or not. For example, event window 124 may have one color to indicate that the event has been reserved, and may have another color to indicate that the event has not been reserved. A previously reserved event may be cancelled by dragging the event from scheduling window 120 to a waste bin. According to one embodiment, a cancellation penalty may be displayed, and the consumer can select whether to pay the cancellation penalty.

An offered timeframe indicator 128 may be used to indicate times during which the service is offered. For example, offered timeframe indicator 128 may indicate when a restaurant is open. According to one embodiment, offered timeframe indicator 128 may indicate when a service is offered to provide a particular feature. For example, a breakfast timeframe may be defined as between 9:00 a.m. and 11:30 a.m., a lunch timeframe may be defined as between noon and 3:00 p.m., and a dinner timeframe may be defined as between 6:00 p.m. and 11:00 p.m. Offered timeframe indicator 128 may appear in scheduling window 120 as any suitable indicator, for example, a box in scheduling window 120. According to one embodiment, offered timeframe indicator 128 may appear as a service offering is being dragged into scheduling window 120. A service offering might not be able to be inserted outside of an area indicated by timeframe indicator 128.

Availability section 122 displays one or more availability indicators 130 associated with an event. An availability indicator 130 indicates when a service is available during the service offered timeframe 128. For example, availability indicator 130 may indicate that the restaurant has open tables at a particular time. According to the illustrated embodiment, the event for restaurant R1 has triangle availability indicators 130 indicating that tables at restaurant R1 are available at 9:30, 10:00, and 10:30. Although availability indicators 130 are illustrated as triangles, any other suitable graphic indicator may be used as an availability indicator 130.

Availability indicators 130 may be dynamically generated. When a service offering is dropped in a service offered timeframe 128, consumer agent 62 may contact the service providing the service offering and query whether the service is available given the consumer descriptors listed in specifications section 116. The service returns the available times for the timeframe given the consumer descriptors, and availability indicators 130 are displayed to indicate the available times. Availability indicators 130 may also be dynamically updated in response to information from other agents. For example, a restaurant service 80 may indicate that tables are not available during certain times, and availability indicators 130 may be updated in response to that information.

Availability indicators 130 may be used to select a time for an event. For example, an event window 124 may be snapped from the time indicated by the consumer to the nearest time indicated by an availability indicator 130. As another example, event window 124 may be dragged to a time corresponding to an availability indicator 130. As another example, an availability indicator 130 may be selected to move event window 124 to the time corresponding to the availability indicator 130. Furthermore, an availability indicator 130 may be selected in order to change a time that was previously selected.

Tabs 118 include selectors that may be used to access different windows of planner 100. According to the illustrated embodiment, tabs 118 includes a make reservations tab, a set preferences tab, and a to-do tab. A make reservations tab may be used to make reservations for the events of timeline 110. A set preferences tab may be used to input consumer preferences. A to-do tab may be used to display a calendar view of the reserved events. An event of the calendar view may be selected in order to view the timeline 110 that includes the event. An event may be cancelled by dragging the corresponding event window 124 from the calendar view to a waste bin. According to one embodiment, a cancellation penalty may be displayed.

Alterations or permutations such as modifications, additions, or omissions may be made to planner 100 without departing from the scope of the invention. For example, the particular language and identifiers used for planner 100 may be chosen from any number of possibilities, and planner 100 may conform to any appropriate scheme for building an itinerary.

FIG. 6 is a flowchart illustrating one embodiment of a method for building an itinerary. The method begins at step 210, where consumer agent 62 receives consumer descriptors. Consumer descriptors may include consumer preferences and consumer requirements. Services are selected according to the consumer descriptors at step 214. For example, services may be selected according to compatibility with consumer requirements by any suitable agent such as consumer agent 62 or service finder 70.

Prioritization information is received at step 218. Prioritization information may include, for example, compatibility metrics, proximity metrics from geographic agent 64, evaluation metrics from recommendation agent 66, other suitable prioritization information, or any combination of the preceding. The services are prioritized according to the prioritization information at step 222. For example, consumer agent 62 may prioritize the service offerings with respect to suitability calculated from the compatibility, proximity, evaluation metrics, other suitable metric, or any combination of the preceding. Recommended services are selected from the prioritized services at step 224. For example, the top five services may be selected. Consumer agent 62 receives an advertisement from advertising agent 68 at step 226. Advertising agent 68 may select a targeted advertisement in accordance with the consumer descriptors.

The recommended services are presented in recommended services section 112 for the consumer to select, and the advertisement may also be presented at step 228. Consumer agent 62 detects that a service offering has been selected at step 230. Consumer agent 62 indicates a service offered timeframe at step 232 where the service offering may be placed. The service offered timeframe may be indicated by offered timeframe indicator 128. Consumer agent 62 determines available times for the service within the service offered timeframe at step 236. For example, consumer agent 62 may query services in order to determine the available times. The available times are presented at step 238. For example, the available times may be displayed using available time indicators 130. The event window 124 may snap to the time of the nearest availability indicator 130. Consumer agent 62 detects selection of an available time at step 240. For example, the user may move event window 124 to a time corresponding to an availability indicator 130.

Consumer agent 62 determines whether there is a selection of a next service offering at step 242. If there is a selection of a next service offering, the method returns to step 232 to indicate the service offered timeframe for the next service offering. If there is no next service offering at step 242, the method proceeds to step 244. Consumer agent 62 makes reservations for the service offerings of timeline 110 at step 244. For example, reservations may be made by contacting service finders 70 or the services themselves. After making reservations, the method terminates.

The flowchart and description provided illustrate a brief method for consumer agent 22 to provide itinerary generation. The flowchart and description, however, illustrate only an exemplary method of operation, and system 10 contemplates agents, other suitable components, or both agents and other suitable components using any appropriate techniques to provide these functionalities. Many of the steps of the flowchart may take place simultaneously, in different order, or both simultaneously and in different order than as shown. In addition, agents may use methods with additional steps, fewer steps, different steps, or any combination of the preceding so long as the methods remain appropriate.

Although the present invention has been described in several embodiments, a myriad of changes and modifications may be suggested to one skilled in the art, and it is intended that the present invention encompass such changes and modifications as fall within the scope of the present appended claims.

1. A method for building an itinerary, comprising:
receiving one or more consumer descriptors at a consumer agent operating on behalf of a consumer;
identifying a plurality of recommended services from a plurality of services using a service agent operating as a service finder, the recommended services identified in accordance with the one or more consumer descriptors, each service of the plurality of services associated with a service description;
presenting a timeline and the recommended services;
repeating the following until a selection of one or more service offerings has been completed to build an itinerary of one or more events:
determining a selection of a service offering of the recommended services as an event for the itinerary, the service offering selected using the timeline;
indicating one or more available times of the selected service offering; and
determining a selection of an available time of the one or more available times of the selected service offering, the available time selected using the timeline.

2. The method of claim 1, wherein identifying the recommended services from the services using the service agent further comprises:
comparing the service descriptions with the one or more consumer descriptors comprising a consumer requirement; and
identifying the recommended services in accordance with the comparison.

3. The method of claim 1, wherein identifying the recommended services from the services using the service agent further comprises:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information; and
identifying the recommended services in accordance with the prioritization.

4. The method of claim 1, wherein identifying the recommended services from the services using the service agent further comprises:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information, the compatibility metric being weighted higher than the proximity metric, the proximity metric being weighted higher than the evaluation metric; and
identifying the recommended services in accordance with the prioritization.

5. The method of claim 1, wherein determining the selection of the available time of the one or more available times of the selected service offering further comprises:
indicating an offered timeframe substantially during which the selected service offering is offered;
receiving a selection of the selected service offering substantially within the offered timeframe; and
indicating the one or more available times of the selected service offering substantially within the offered timeframe.

6. The method of claim 1, wherein determining the selection of the service offering of the recommended services as an event for the itinerary further comprises detecting that the service offering has been placed in the timeline.

7. The method of claim 1, wherein receiving the selection of the available time further comprises detecting that the service offering has been placed at a time corresponding to the available time.

8. The method of claim 1, wherein the timeline comprises a fuzzy timeline undivided by a plurality of fixed time segments.

9. A system for building an itinerary, comprising:
a database operable to store one or more consumer descriptors associated with a consumer; and
one or more agents coupled to the database and operable to:
identify a plurality of recommended services from a plurality of services using a service agent operating as a service finder, the recommended services identified in accordance with the one or more consumer descriptors, each service of the plurality of services associated with a service description;
present a timeline and the recommended services;
repeat the following until a selection of one or more service offerings has been completed to build an itinerary of one or more events:
determine a selection of a service offering of the recommended services as an event for the itinerary, the service offering selected using the timeline;
indicate one or more available times of the selected service offering; and
determine a selection of an available time of the one or more available times of the selected service offering, the available time selected using the timeline.

10. The system of claim 9, wherein the one or more agents are operable to identify the recommended services from the services using the service agent by:
comparing the service descriptions with the one or more consumer descriptors comprising a consumer requirement; and
identifying the recommended services in accordance with the comparison.

11. The system of claim 9, wherein the one or more agents are operable to identify the recommended services from the services using the service agent by:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information; and
identifying the recommended services in accordance with the prioritization.

12. The system of claim 9, wherein the one or more agents are operable to identify the recommended services from the services using the service agent by:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information, the compatibility metric being weighted higher than the proximity metric, the proximity metric being weighted higher than the evaluation metric; and
identifying the recommended services in accordance with the prioritization.

13. The system of claim 9, wherein the one or more agents are operable to determine the selection of the available time of the one or more available times of the selected service offering by:
indicating an offered timeframe substantially during which the selected service offering is offered;
receiving a selection of the selected service offering substantially within the offered timeframe; and
indicating the one or more available times of the selected service offering substantially within the offered timeframe.

14. The system of claim 9, wherein the one or more agents are operable to determine the selection of the service offering of the recommended services as an event for the itinerary by detecting that the service offering has been placed in the timeline.

15. The system of claim 9, wherein the one or more agents are operable to receive the selection of the available time by detecting that the service offering has been placed at a time corresponding to the available time.

16. The system of claim 9, wherein the timeline comprises a fuzzy timeline undivided by a plurality of fixed time segments.

17. Logic for building an itinerary, the logic embodied in a computer-readable medium and operable to:
receive one or more consumer descriptors at a consumer agent operating on behalf of a consumer;
identify a plurality of recommended services from a plurality of services using a service agent operating as a service finder, the recommended services identified in accordance with the one or more consumer descriptors, each service of the plurality of services associated with a service description;
present a timeline and the recommended services;
repeat the following until a selection of one or more service offerings has been completed to build an itinerary of one or more events:
determine a selection of a service offering of the recommended services as an event for the itinerary, the service offering selected using the timeline;
indicate one or more available times of the selected service offering; and
determine a selection of an available time of the one or more available times of the selected service offering, the available time selected using the timeline.

18. The logic of claim 17, operable to identify the recommended services from the services using the service agent by:
comparing the service descriptions with the one or more consumer descriptors comprising a consumer requirement; and
identifying the recommended services in accordance with the comparison.

19. The logic of claim 17, operable to identify the recommended services from the services using the service agent by:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information; and
identifying the recommended services in accordance with the prioritization.

20. The logic of claim 17, operable to identify the recommended services from the services using the service agent by:
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information, the compatibility metric being weighted higher than the proximity metric, the proximity metric being weighted higher than the evaluation metric; and
identifying the recommended services in accordance with the prioritization.

21. The logic of claim 17, operable to determine the selection of the available time of the one or more available times of the selected service offering by:
indicating an offered timeframe substantially during which the selected service offering is offered;
receiving a selection of the selected service offering substantially within the offered timeframe; and
indicating the one or more available times of the selected service offering substantially within the offered timeframe.

22. The logic of claim 17, operable to determine the selection of the service offering of the recommended services as an event for the itinerary by detecting that the service offering has been placed in the timeline.

23. The logic of claim 17, operable to receive the selection of the available time by detecting that the service offering has been placed at a time corresponding to the available time.

24. The logic of claim 17, wherein the timeline comprises a fuzzy timeline undivided by a plurality of fixed time segments.

25. A system for building an itinerary, comprising:
means for receiving one or more consumer descriptors at a consumer agent operating on behalf of a consumer;
means for identifying a plurality of recommended services from a plurality of services using a service agent operating as a service finder, the recommended services identified in accordance with the one or more consumer descriptors, each service of the plurality of services associated with a service description;
means for presenting a timeline and the recommended services;
means for repeating the following until a selection of one or more service offerings has been completed to build an itinerary of one or more events:
determining a selection of a service offering of the recommended services as an event for the itinerary, the service offering selected using the timeline;
indicating one or more available times of the selected service offering; and
determining a selection of an available time of the one or more available times of the selected service offering, the available time selected using the timeline.

26. A method for building an itinerary, comprising:
receiving one or more consumer descriptors at a consumer agent operating on behalf of a consumer;
identifying a plurality of recommended services from a plurality of services using a service agent operating as a service finder, the recommended services identified in accordance with the one or more consumer descriptors, each service of the plurality of services associated with a service description, the recommended services identified by:
comparing the service descriptions with the one or more consumer descriptors comprising a consumer requirement;
identifying the recommended services in accordance with the comparison;
receiving prioritization information associated with the services, the prioritization information comprising at least one of a compatibility metric, a proximity metric, and an evaluation metric for a service, the compatibility metric measuring compatibility of the service and the one or more consumer descriptors, the proximity metric measuring the distance between the service and a consumer location of the consumer, the evaluation metric measuring at least one of a popularity and a rating of the service;
prioritizing the services in accordance with the prioritization information, the compatibility metric being weighted higher than the proximity metric, the proximity metric being weighted higher than the evaluation metric; and
identifying the recommended services in accordance with the prioritization and the comparison;
presenting a timeline and the recommended services, the timeline comprising a fuzzy timeline undivided by a plurality of fixed time segments;
repeating the following until a selection of one or more service offerings has been completed to build an itinerary of one or more events:
determining a selection of a service offering of the recommended services as an event for the itinerary, the service offering selected using the timeline, the selection of the service offering determined by detecting that the service offering has been placed in the timeline;
indicating one or more available times of the selected service offering, the one or more available times indicated by:
indicating an offered timeframe substantially during which the selected service offering is offered;
receiving a selection of the selected service offering substantially within the offered timeframe;
indicating the one or more available times of the selected service offering substantially within the offered timeframe; and
determining a selection of an available time of the one or more available times of the selected service offering, the available time selected using the timeline, the selection of the available time determined by detecting that the service offering has been placed at a time corresponding to the available time.
